(19) United States
(12) Patent Application Publication
(10) Pub. No.: US 2023/0171791 A1
(43) Pub. Date: Jun. 1, 2023

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/161,749

(22) Filed: Jan. 30, 2023

Related U.S. Application Data
(63) Continuation of application No. PCT/JP2021/027608, filed on Jul. 26, 2021.
(60) Provisional application No. 63/058,713, filed on Jul. 30, 2020.

(51) Int. Cl. H04W 72/30; H04W 72/543

(52) U.S. Cl. CPC H04W 72/30; H04W 72/543

(57) ABSTRACT

A first aspect provides a communication control method used in a mobile communication system including a base station for providing a multicast broadcast service (MBS) to a user equipment, the communication control method including transmitting, by the base station configured to manage a cell, in the cell, a plurality of MBS control channels associated with respective different service quality requirements, and receiving, by the user equipment, an MBS control channel of the plurality of MBS control channels corresponding to a service quality requirement of the different service quality requirements requested by the user equipment.

### RELATED APPLICATIONS

The present application is a continuation based on PCT Application No. PCT/JP2021/027608, filed on Jul. 26, 2021, which claims the benefit of U.S. Provisional Application No. 63/058,713 filed on Jul. 30, 2020. The content of which is incorporated by reference herein in their entirety.

### TECHNICAL FIELD

The present disclosure relates to a communication control method used in a mobile communication system.

### BACKGROUND OF INVENTION

In recent years, a mobile communication system of the fifth generation (5G) has attracted attention. New Radio (NR), which is a Radio Access Technology (RAT) of the 5G System, has features such as high speed, large capacity, high reliability, and low latency compared to Long Term Evolution (LTE), which is a fourth generation radio access technology.

### CITATION LIST

### Non-Patent Literature

NPL 1: 3GPP Technical Specification “3GPP TS 38.300 V16.2.0 (2020-07)”

### SUMMARY

A first aspect provides a communication control method used in a mobile communication system including a base station for providing a multicast broadcast service (MBS) to a user equipment, the communication control method including transmitting, by the base station configured to manage a cell, in the cell, a plurality of MBS control channels associated with respective different service quality requirements, and receiving, by the user equipment, an MBS control channel of the plurality of MBS control channels corresponding to a service quality requirement of the different service quality requirements requested by the user equipment.

A second aspect provides a communication control method used in a mobile communication system including a base station for providing a multicast broadcast service (MBS) to a user equipment, the communication control method including transmitting, by the base station, MBS system information via a broadcast control channel, wherein the MBS system information includes first MBS system information indicating scheduling of an MBS control channel for transmitting MBS control information and second MBS system information indicating scheduling of an MBS traffic channel for transmitting MBS data.

A third aspect provides a communication control method used in a mobile communication system including a base station for providing a multicast broadcast service (MBS) to a user equipment, the communication control method including transmitting, by the user equipment, to the base station, a transmission request for requesting transmission of MBS control information via an MBS control channel, and transmitting, by the base station, the MBS control information via the MBS control channel in response to reception of the transmission request.

A fourth aspect provides a communication control method used in a mobile communication system including a base station for providing a multicast broadcast service (MBS) to a user equipment, the communication control method including transmitting, by the user equipment, to the base station, a unicast transmission request for specifying MBS system information transmitted via a broadcast control channel and/or MBS control information transmitted via an MBS control channel, and transmitting, by the base station, to the user equipment via unicast, information specified in the unicast transmission request, in response to reception of the unicast transmission request.

A fifth aspect provides a communication control method used in a mobile communication system including a base station for providing a multicast broadcast service (MBS) to a user equipment, the communication control method including transmitting, by the base station, to the user equipment, a session initiation notification including an MBS service identifier corresponding to an MBS session when the base station starts to provide the MBS session.

A sixth aspect provides a communication control method used in a mobile communication system including a base station for providing a multicast broadcast service (MBS) to a user equipment, the communication control method including transmitting, by the base station configured to manage a cell, to the user equipment, an MBS service identifier corresponding to an MBS session and bandwidth part information associated with the MBS service identifier, wherein the bandwidth part information indicates a first bandwidth part used to provide the MBS session in the cell.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE 100) according to an embodiment.

FIG. 3 is a diagram illustrating a configuration of a base station (gNB 200) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signalling (control signal).

FIG. 6 is a diagram illustrating a correspondence relationship between a downlink Logical channel and a downlink Transport channel according to an embodiment.

FIG. 7 is a diagram illustrating a communication control method according to a first embodiment.

FIG. 8 is a diagram illustrating an example of operations according to the first embodiment.

FIG. 9 is a diagram illustrating a correspondence relationship between channels according to a second embodiment.

FIG. 10 is a diagram illustrating an example of operations according to the second embodiment.

FIG. 11 is a diagram illustrating an example of operations according to a third embodiment.

FIG. 12 is a diagram illustrating an example of operations according to a fourth embodiment.

FIG. 13 is a diagram illustrating an example of operations according to a fifth embodiment.

FIG. 14 is a diagram illustrating an example of BWPs.

FIG. 15 is a diagram illustrating an example of operations according to a sixth embodiment.

FIG. 16 is a diagram illustrating a two-stage configuration in LTE SC-PTM.

FIG. 17 is a diagram illustrating enhancements of functions for an NR MBS.

FIG. 18 is a diagram illustrating a U-plane architecture of an LTE MBMS.

FIG. 19 is a diagram illustrating enhancements of functions for reliable reception and multicast/unicast switching.

### DESCRIPTION OF EMBODIMENTS

Introduction of multicast broadcast services to the 5G system (NR) has been under study. NR multicast broadcast services are desired to provide enhanced services compared to LTE multicast broadcast services.

The present disclosure provides enhanced multicast broadcast services.

A mobile communication system according to an embodiment will be described with reference to the drawings. In the description of the drawings, the same or similar parts are denoted by the same or similar reference signs.

Configuration of Mobile Communication System

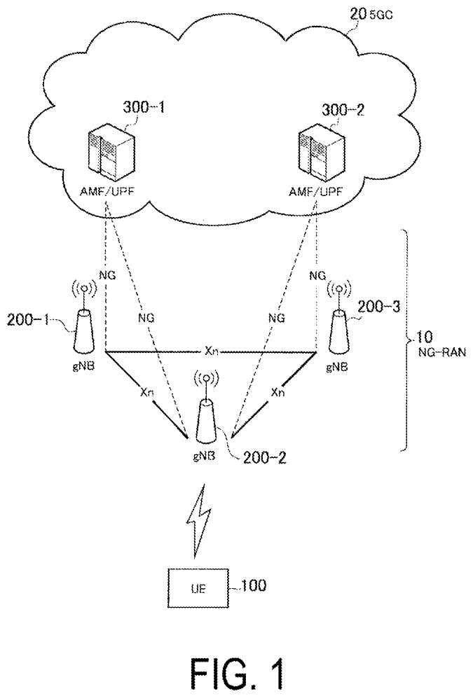

First, a configuration of a mobile communication system according to an embodiment will be described. FIG. 1 is a diagram illustrating a configuration of the mobile communication system according to an embodiment. This mobile communication system complies with the 5th Generation System (5GS) of the 3GPP standard. The description below takes the 5GS as an example, but Long Term Evolution (LTE) system may be at least partially applied to the mobile communication system.

As illustrated in FIG. 1, the mobile communication system includes a user equipment (UE) 100, a 5G radio access network (next generation radio access network (NG-RAN)) 10, and a 5G core network (5GC) 20.

The UE 100 is a mobile wireless communication apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or a plurality of cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signalling. The UPF controls data transfer. The AMF and UPF are connected to the gNB 200 via an NG interface which is an interface between a base station and the core network.

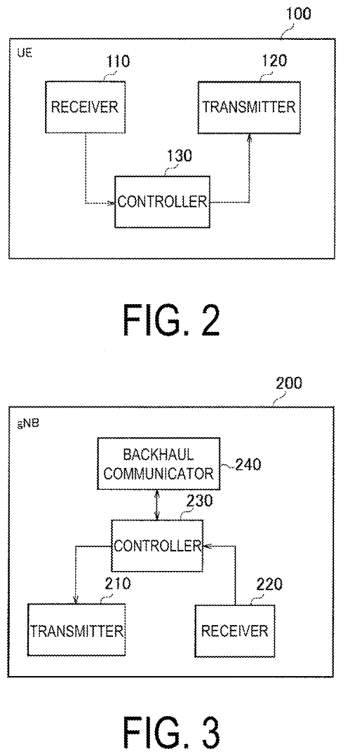

FIG. 2 is a diagram illustrating a configuration of the UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal output by the controller 130 (a transmission signal) into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

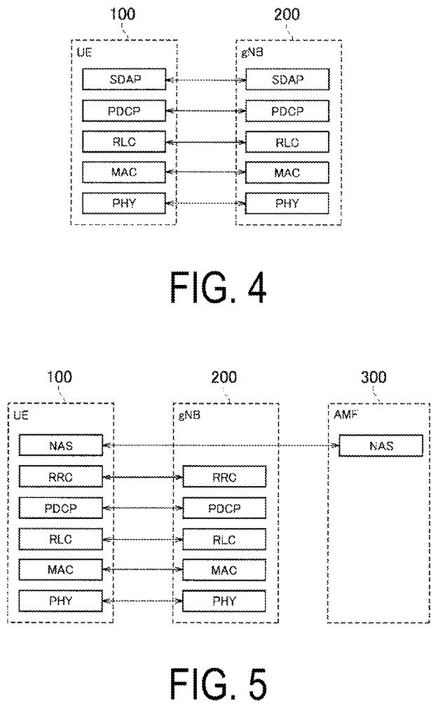

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARM), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of QoS control by a core network and a radio bearer as the unit of QoS control by an access stratum (AS). Note that, when the RAN is connected to the EPC, the SDAP may not be provided.

FIG. 5 is a diagram illustrating a configuration of a protocol stack of a radio interface of a control plane handling signalling (control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signalling for various configurations is transmitted between the RRC layer of the UE 100 and the RRC layer of the gNB 200. The RRC layer controls a logical channel, a transport channel, and a physical channel according to establishment, reestablishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is higher than the RRC layer performs session management, mobility management, and the like. NAS signalling is transmitted between the NAS layer of the UE 100 and the NAS layer of the AMF 300.

Note that the UE 100 includes an application layer other than the protocol of the radio interface.

MBS

An MBS according to an embodiment will be described. The MBS is a service in which the NG-RAN 10 provides broadcast or multicast, that is, point-to-multipoint (PTM) data transmission to the UE 100. The MBS may be referred to as the Multimedia Broadcast and Multicast Service (MBMS). Note that use cases (service types) of the MBS include public communication, mission critical communication, V2X (Vehicle to Everything) communication, IPv4 or IPv6 multicast delivery, IPTV, group communication, and software delivery.

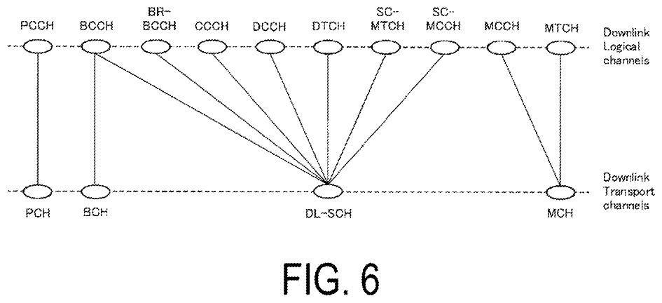

MBS Transmission in LTE includes two schemes, i.e., a Multicast Broadcast Single Frequency Network (MBSFN) transmission and Single Cell Point-To-Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Control Channel (MCH). The MBSFN transmission is designed primarily for multi-cell transmission, and in an MBSFN area including a plurality of cells, each cell synchronously transmits the same signal (the same data) in the same MBSFN subframe.

The logical channels used for SC-PTM transmission are a Single Cell Multicast Traffic Channel (SC-MTCH) and a Single Cell Multicast Control Channel (SC-MCCH), and the transport channel used for SC-PTM transmission is a Downlink Shared Channel (DL-SCH). The SC-PTM transmission is primarily designed for single-cell transmission, and corresponds to broadcast or multicast data transmission on a cell-by-cell basis. The physical channels used for SC-PTM transmission are a Physical Downlink Control Channel (PDCCH) and a Physical Downlink Shared Channel (PDSCH), and enables dynamic resource allocation.

Although an example will be mainly described below in which the MBS is provided using the SC-PTM transmission scheme, the MBS may be provided using the MBSFN transmission scheme. An example will be mainly described in which the MBS is provided using multicast. Accordingly, the MBS may be interpreted as multicast. Note that, the MBS may be provided using broadcast.

In the following, MBS data refers to data transmitted by the MBS. An MBS control channel refers to the MCCH or SC-MCCH, and an MBS traffic channel refers to the MTCH or SC-MTCH.

The network can provide different MBS services for respective MBS sessions. The MBS session (MBS service) is identified by at least one of Temporary Mobile Group Identity (TMGI) and a session identifier, and at least one of these identifiers is referred to as an MBS service identifier. Such an MBS service identifier may be referred to as an MBS session identifier or a multicast group identifier.

### First Embodiment

With the mobile communication system and MBS described above as the assumption, a communication control method according to a first embodiment will be described.

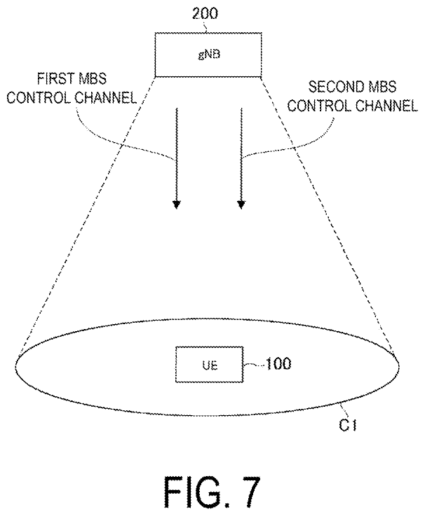

FIG. 7 is a diagram illustrating a communication control method according to the first embodiment.

As illustrated in FIG. 7, the communication control method according to the first embodiment is a method used in a mobile communication system in which the gNB 200 provides a multicast broadcast service (MBS) to the UE 100. The communication control method according to the first embodiment includes the steps of performing, by the gNB 200 managing a cell C1, transmission, in the cell C1, of a plurality of MBS control channels associated with respective different service quality requirements, and receiving, at the UE 100, an MBS control channel corresponding to the service quality requirement requested by the UE 100 among the plurality of MBS control channels.

In this way, in the first embodiment, the plurality of MBS control channels are configured in the one cell C1, and the plurality of MBS control channels are associated with the respective different service quality requirements (or service categories). This enables an MBS control channel optimized according to the service quality requirement to be configured.

In the first embodiment, the plurality of MBS control channels may include a first MBS control channel for a predetermined MBS service and a second MBS control channel for an MBS service which requires a low latency compared to the predetermined MBS service. In other words, the plurality of MBS control channels are classified into an MBS control channel (second MBS control channel) for delay-sensitive services and an MBS control channel (first MBS control channel) for other services.

This enables configuration for the gNB 200 to set the time interval for transmitting the second MBS control channel shorter than the time interval for transmitting the first MBS control channel, facilitating immediate reception of a delay-sensitive service at the UE 100. Note that the UE 100 may receive the second MBS control channel if the UE 100 desires to receive the delay-sensitive service, and need not receive the second MBS control channel if the UE 100 does not desire to receive the delay-sensitive service.

In the first embodiment, the plurality of MBS control channels may be associated with respective different network slices. The network slices refer to logical networks obtained by virtually dividing a network. The network slices can provide services with different service quality requirements. Each network slice is identified by a network slice identifier, e.g., Network Slice Selection Assist Information (NSSAI). In this manner, by associating each MBS control channel with a network slice, an optimized MBS control channel can be configured for each network slice.

In the first embodiment, each of the plurality of MBS control channels may transmit MBS control information including a network slice identifier identifying the corresponding network slice. This allows the UE 100 to easily know which MBS control channel corresponds to which network slice.

In the first embodiment, the gNB 200 or the UE 100 may receive, from a network node, a network slice identifier associated with the MBS service identifier. The network node refers to a node including one or more apparatuses provided in a core network (5GC 20) or even an upper network.

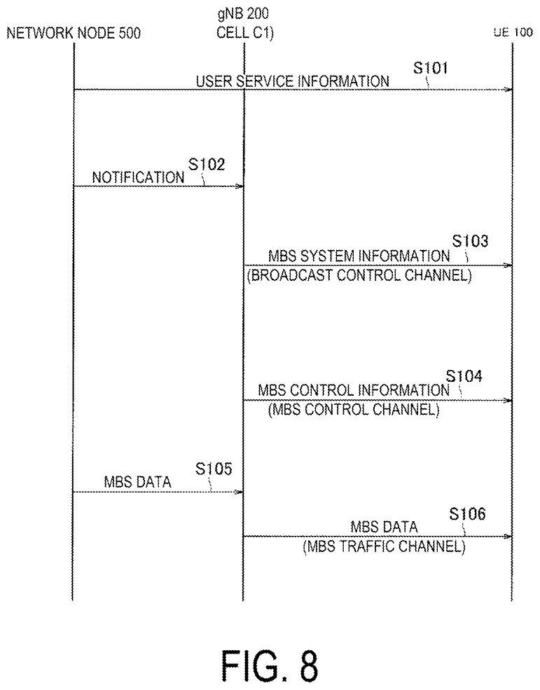

FIG. 8 is a diagram illustrating an example of operations according to the first embodiment. The procedure of the operations illustrated in FIG. 8 can also be applied to each of the embodiments described below.

As illustrated in FIG. 8, in step S101, the network node 500 transmits user service information (USD: User Service Description) to the UE 100. The UE 100 receives the user service information.

The user service information is information of an application layer (service layer). The user service information includes, for each MBS service, at least one selected from the group consisting of an MBS service identifier (e.g., TMGI), a start time and an end time of the MBS session, a frequency, and an MBMS service area identifier. In the first embodiment, the user service information may include a network slice identifier for each MBS service. Based on the user service information, the UE 100 may request, from the network node 500, access right to a network slice indicated by a network slice identifier corresponding to the MBS service that the UE 100 desires to receive.

In step S102, the network node 500 transmits, to the gNB 200, a notification including at least one set of an MBS service identifier and a network slice identifier. The gNB 200 receives the notification. This notification may indicate that the provision of an MBS service (MBS session) indicated by the MBS service identifier is to be started.

In step S103, the gNB 200 transmits MBS system information to the UE 100 via a Broadcast Control Channel (BCCH). The MBS system information is transmitted by broadcast using a predetermined Radio Network Temporary Identifier (RNTI). The UE 100 receives the MBS system information. Note that the system information may be referred to as System Information Blocks (SIBs).

The MBS system information includes scheduling information required for receiving the MBS control channel. For example, the MBS system information includes at least one selected from the group consisting of information indicating a periodicity at which the content (MBS control information) of the MBS control channel may be changed, information indicating the time interval of the MBS control channel transmission in terms of the number of radio frames, information indicating an offset of the radio frame in which the MBS control channel is scheduled, and information indicating a subframe in which the MBS control channel is scheduled.

In the first embodiment, the MBS system information includes the scheduling information of each of the plurality of MBS control channels used in the cell C1 of the gNB 200. For example, the scheduling configuration is made in which the time interval for transmitting the second MBS control channel is shorter than the time interval for transmitting the first MBS control channel.

In the first embodiment, the MBS system information may include the identifier (name) of each of the plurality of MBS control channels. Such an MBS control channel identifier may include a predetermined tag. For example, the second MBS control channel is represented as “SC-MCCH-delay-sensitive-services”, and the second MBS control channel is represented as “SC-MCCH-other-services”. Alternatively, an abstracted MBS control channel identifier may be used such as “SC-MCCH-A”, or “SC-MCCH-B”. In this case, the MBS system information may include information indicating which MBS control channel is intended for low latency.

In the first embodiment, the MBS system information may include a network slice identifier for each MBS control channel. The MBS system information may include a set of a network slice identifier and an MBS service identifier for each MBS control channel. The MBS system information may include, for each network slice identifier, MBS control channel information (such as scheduling information) and/or an MBS service identifier. Alternatively, the MBS system information may include MBS control channel information and/or a network slice identifier for each MBS service identifier. The MBS control channel information, the MBS service identifier and/or the network slice identifier may be associated with each other in each entry of a configuration list.

In step S104, the gNB 200 transmits a plurality of MBS control channels (a plurality of pieces of MBS control information) in accordance with a schedule complying with the MBS system information transmitted in step S103. The MBS control information is transmitted by broadcast (or multicast) using a predetermined RNTI. The RNTI may vary with each MBS control channel.

Each MBS control channel includes a list including scheduling information for the MBS traffic channel for each MBS service belonging to a corresponding service category. For example, the scheduling information for the MBS traffic channel includes an MBS service identifier (e.g., TMGI) and a group RNTI corresponding to the MBS traffic channel, and Discontinuous Reception (DRX) information (or scheduling information) for the MBS traffic channel. Group RNTIs are mapped to MBS service identifiers on a one-to-one basis.

The UE 100 receives only the MBS control channel corresponding to the service quality requirement (service category) required by the UE 100 among the plurality of MBS control channels based on the MBS system information received in step S103. For example, when taking no interest in a low latency service, the UE 100 receives no MBS control channel intended for low latency. This enables waiting with low consumption power. The UE 100 may receive only the MBS control channel corresponding to a network slice that is accessible to the UE 100 (i.e., the network slice to which the UE 100 has the access right or with which the UE 100 is already registered) or a network slice in which UE 100 takes interest. Note that, based on the MBS system information received in step S103, the UE 100 may receive only the MBS control channel corresponding to the service quality requirement (service category) of the identifier (e.g., TMGI) of the MBS service in which the UE 100 takes interest.

In step S105, the network node 500 transmits MBS data to the gNB 200. The gNB 200 receives the MBS data.

In step S106, the gNB 200 transmits, via the MBS traffic channel, the MBS data received from the network node 500. The MBS data is transmitted by multicast (or broadcast) using the group RNTI. The UE 100 receives only the MBS data corresponding to the service quality requirement (service category) required by the UE 100 based on the MBS control information received in step S104. For example, when taking no interest in low delay services, the UE 100 receives no MBS data for services intended for low latency. The UE 100 may receive only the MBS data corresponding to a network slice that is accessible to the UE 100 (i.e., the network slice to which the UE 100 has the access right or with which the UE 100 is already registered) or a network slice in which UE 100 takes interest. Note that the UE 100 may receive only the MBS data corresponding to the service quality requirement (service category) of the identifier (e.g., TMGI) of an MBS service in which the UE 100 takes interest.

### Second Embodiment

A second embodiment will be described while focusing on differences from the above-described embodiment.

In the embodiment described above, the UE 100 receives the MBS control channel in order to receive the MBS traffic channel and receives the broadcast control channel in order to receive the MBS control channel. Due to the need for such three-stage reception processing, MBS services that are tolerant of no access delay have room for enhancement.

The MBS control channel can be more frequently updated than the broadcast control channel. Accordingly, although the MBS control channel enables the MBS traffic channel to be frequently updated, the MBS traffic channel may not need to be frequently updated.

Thus, in the second embodiment, the scheduling information for the MBS traffic channel can be transmitted in the broadcast control channel (MBS system information).

The communication control method according to the second embodiment includes the step of transmitting, by the gNB 200, the MBS system information via the broadcast control channel. The MBS system information includes first MBS system information indicating the scheduling of the MBS control channel for transmitting the MBS control information and second MBS system information indicating the scheduling of the MBS traffic channel for transmitting the MBS data. The first MBS system information may hereinafter be referred to as the SIBy, and the second MBS system information may hereinafter be referred to as the SIBx.

In this manner, transmitting the SIBx indicating the scheduling of the MBS traffic channel as well as the SIBy indicating the scheduling of the MBS control channel facilitates suppressing a possible delay.

In the second embodiment, the UE 100 may transmit, to the gNB 200, a transmission request requesting transmission of the MBS system information. The transmission request includes information identifying, out of the SIBy and the SIBx, the MBS system information requested by the UE 100. Thus, the UE 100 can immediately acquire the MBS system information required by the UE 100 from the gNB 200.

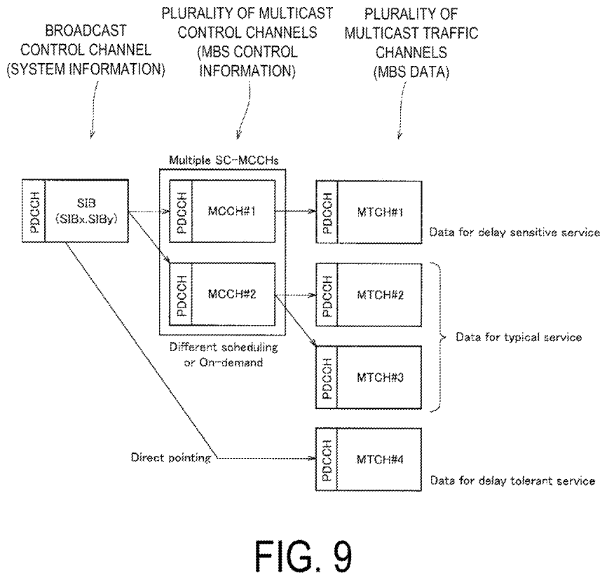

FIG. 9 is a diagram illustrating a correspondence relationship between the channels according to the second embodiment. Each channel illustrated in FIG. 9 is provided in one cell. Although an example is illustrated in which the second embodiment is used in conjunction with the first embodiment, the second embodiment need not necessarily be used in conjunction with the first embodiment.

While each block illustrated in FIG. 9 represents a single channel, the description “PDCCH” in each block means that a radio resource of the channel (PDSCH) is allocated by the PDCCH in the physical layer. That is, the assumption is that all of the broadcast control channel, the MBS control channel, and the MBS traffic channel are mapped to DL-SCH.

As illustrated in FIG. 9, the MBS system information transmitted in the broadcast control channel includes the SIBy indicating the scheduling of the MBS control channel and the SIBx indicating the scheduling of the MBS traffic channel. Note that the MBS system information may be transmitted at a periodicity scheduled by a predetermined type of SIB (e.g., SIB type 1), or may be transmitted in response to a request from the UE 100 (i.e., on demand).

The SIBx can directly point to an MBS traffic channel (MTCH #4) without the use of the MBS control channel (i.e., direct pointing). This MTCH #4 is, for example, an MBS traffic channel for transmitting MBS data for delay tolerant MBS service (Data for delay tolerant service).

The SIBy refers to each of a plurality of MBS control channels ((SC-)MCCH #1 and (SC-)MCCH #2). As described in the first embodiment, different scheduling operations are applicable to the respective MBS control channels. Note that the MBS control channel may be transmitted at a periodicity indicated by the SIBy or may be transmitted in response to a request from the UE 100 (i.e., on demand). The latter case will be described in the third embodiment.

FIG. 9 illustrates an example in which (SC-)MCCH #1 points to one MBS traffic channel (MTCH #1), and (SC-)MCCH #2 points to two MBS traffic channels (MTCH #2 and MTCH #3). MTCH #1 is an MBS traffic channel for transmitting MBS data for delay sensitive MBS service (Data for delay sensitive service). MTCH #2 and MTCH #3 are MBS traffic channels for transmitting MBS data of typical MBS service (Data for typical service).

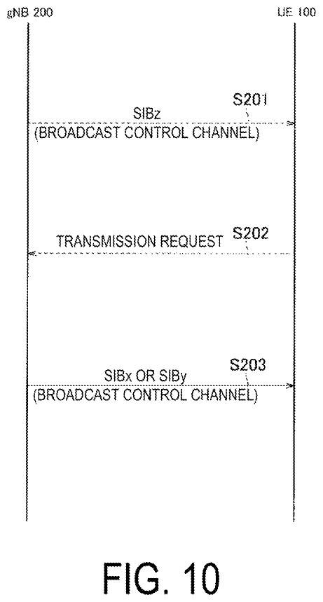

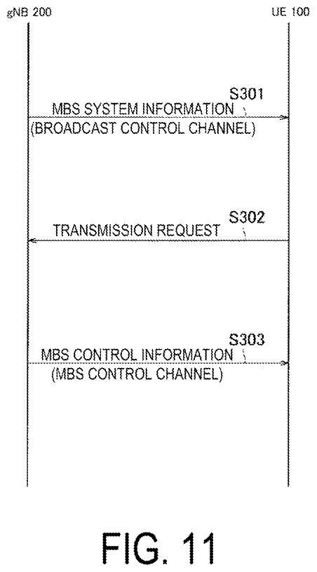

FIG. 10 is a diagram illustrating an example of operations according to the second embodiment. In FIG. 10, dashed lines illustrate steps that are optional.

As illustrated in FIG. 10, in step S201, the gNB 200 transmits, via the broadcast control channel, system information (hereinafter referred to as SIBz) including mapping information for MBS service identifiers mapped to the SIBx and the SIBy. In other words, the mapping information indicates which SIB contains information for reception of the MBS control channel and which SIB contains information for reception of the MBS traffic channel.

Upon receiving SIBz, the UE 100 identifies, based on the SIBz, the SIB associated with the MBS service identifier of the MBS service that the UE 100 desires to receive. In step S202, the UE 100 transmits a transmission request to the gNB 200 in a manner in which the identified SIB (SIBx or SIBy) is identifiable. For example, the UE 100 transmits an RRC message including the identifier of the identified SIB (SIBx or SIBy), to the gNB 200 as a transmission request. Alternatively, the UE 100 transmits a random access preamble to the gNB 200 as a transmission request using a PRACH resource associated with the identified SIB (SIBx or SIBy).

In step S203, the gNB 200 transmits, via the broadcast control channel, the SIB (SIBx or SIBy) identified in the transmission request from the UE 100. Alternatively, the gNB 200 may transmit the SIBx or the SIBy to the UE 100 by using unicast instead of broadcast transmission of the SIBx or the SIBy. Such unicast transmission will be described in a fourth embodiment.

As described above, the SIBx is intended for directly receiving MBS traffic channels, and includes, for each MBS service identifier, at least one of the following information elements, for example.
MBS Traffic Channel scheduling information: On duration timer, DRX inactivity timer, Scheduling period (transmission period), Start offset (transmission SFN offset value), Num repetition (number of repeated transmissions), BWP (transmission BWP information). The details of the BWP (BandwidthPart) will be described in the sixth embodiment. The transmission BWP information includes at least one selected from the group consisting of a Starting PRB and a bandwidth (BWP configuration), an SCS (sub-carrier spacing configuration), and a CP length (cyclic prefix length configuration).
Group RNTI
PDCCH configuration
PDSCH configuration
Neighbor cell information (frequency, cell ID)

On the other hand, the SIBy is intended for receiving the MBS control channel, and includes, for each MBS service identifier, at least one of the following information elements, for example.
MBS Control Channel scheduling Information: Repetition Period (repeated transmission period), Offset (offset value of SFN for scheduling), First subframe (scheduling start subframe), Duration (scheduling period from the first subframe), Modification period, On duration timer, DRX inactivity timer, Scheduling period (transmission period), Start offset (transmission SFN offset value), Num repetition (number of repeated transmissions), and BWP (transmission BWP information). The details of the BWP will be described in a fifth embodiment. The transmission BWP information includes at least one selected from the group consisting of Starting PRB and bandwidth (BWP configuration), an SCS (sub-carrier spacing configuration), and a CP length (cyclic prefix length configuration).
SC-RNTI (RNTI allocated to the MBS control channel. Case is assumed in which SC-RNTI can include a plurality of values)
SC-N-RNTI (RNTI allocated to a notification for change of the MBS control channel. Case is assumed in which SC-N-RNTI can include a plurality of values)
PDCCH configuration
PDSCH configuration
Neighbor cell information (frequency, cell ID)

In step S203, the UE 100 receives a SIB including control information related to the MBS service identifier that the UE 100 desires to receive, and receives the MBS traffic channel or the MBS control channel based on the received SIB.

Note that in the second embodiment, on-demand transmission may also be applied to the SIBz. The gNB 200 may constantly periodically broadcast one of the SIBx and the SIBy and broadcast the other on demand. The constantly periodically broadcast SIB (e.g., the SIBx) may point to the SIBz. The constantly periodically broadcast SIB (e.g., the SIBx) may include mapping information in the SIBz. When the SIBy is present, the SIBx and the SIBy may be transmitted as the same system information. In this case, the transmission request in S202 is transmitted based on the mapping information in the SIBz and the interest of the UE itself (e.g., including the TMGI that the UE desires to receive). In S203, SIBs are provided that include MBS system information and/or MBS control information corresponding to a multicast service in which the UE takes interest.

### Third Embodiment

A third embodiment will be described while focusing on differences from the above-described embodiments.

Transmission occasions are specified for the MBS control channel, but when the MBS control channel is transmitted in all of these transmission occasions, radio resources may be useless. For example, no UE 100 may desire to receive the MBS control channel.

Thus, in the third embodiment, the on-demand transmission is also applicable to the MBS control channel. According to the third embodiment, the communication control method includes the steps of transmitting, from the UE 100 to the gNB 200, a transmission request requesting transmission of the MBS control information via the MBS control channel, and transmitting (broadcasting), by the gNB 200, the MBS control information via the MBS control channel in response to the reception of the transmission request.

FIG. 11 is a diagram illustrating an example of operations according to the third embodiment.

As illustrated in FIG. 11, in step S301, the gNB 200 transmits the MBS system information to the UE 100 via the broadcast control channel. The UE 100 receives the MBS system information. Here, in the on-demand case, the UE 100 requests and receives the MBS system information.

In the third embodiment, the MBS system information includes at least one of the following information elements.

(A) One MBS control channel
An MBS service identifier or a network slice identifier corresponding to the MBS service identifier during multicast (during transmission of the MBS traffic channel)
Information indicating whether the MBS control channel is constantly periodically broadcast or whether the broadcast is stopped (on-demand type)
Scheduling information, BWP information (transmission BWP information described above), and the like for the MBS control channel

(B) A plurality of MBS control channels
An MBS service identifier or a network slice identifier corresponding to the MBS service identifier during multicast (during transmission of the MBS traffic channel)
Information indicating, for each MBS service identifier, whether the MBS control channel is constantly periodically broadcast or whether the broadcast is stopped (on-demand type)
For each MBS service identifier, scheduling information, BWP information (transmission BWP information described above), SC-RNTI information, and the like for the MBS control channel Alternatively, each identifier of the MBS control channel may be provided with an MBS service identifier, and scheduling information, BWP information, and SC-RNTI information for the MBS control channel. (See Table 1) alternatively, each network slice identifier may be provided with an MBS service identifier, the identifier of the MBS control channel, and scheduling information, BWP information, and SC-RNTI information for the MBS control channel. Note that the SC-RNTI refers to the RNTI for the MBS control channel but that this may be another name.

TABLE 1

| | Parent (key) | Child (entry) |
|---|---|---|
| Per MBS | MBS Service Identifier #1 | MBS control channel #1 |
| service | MBS Service Identifier #2 | MBS control channel #2 |
| identifier | MBS Service Identifier #3 | MBS control channel #1 |
| Per MBS | MBS control channel #1 | MBS Service Identifier #1, |
| control | | MBS Service Identifier #3 |
| channel | MBS control channel #2 | MBS Service Identifier #2 |

In step S302, the UE 100 transmits, to the gNB 200, a broadcast request (transmission request) for the MBS control channel based on the MBS system information received in step S301. When a plurality of MBS control channels are provided in the cell, the broadcast request includes an MBS service identifier or the identifier of the MBS control channel. The broadcast request may include identification information indicating whether the information is desired to be acquired early (whether delay is tolerable).

The broadcast request may be an RRC message including the above-described information. The RRC message may be an MBS Interest Indication message as defined by LTE. Note that when the UE 100 is in an RRC idle state or an RRC connected state before broadcast request, the UE 100 may transmit a broadcast request (RRC message) after completing a random access procedure and transitioning to the RRC connected state. Note that in a request for transitioning to the RRC connected state (RRC Setup Request or RRC Resume Request), the UE 100 may notify that the communication is intended for broadcast request. The notification may be provided as a cause that is one of the information elements in the transition request message.

The broadcast request may be a random access preamble transmitted using PRACH resources for broadcast request. When a plurality of MBS control channels are provided, the MBS control channels may be identified by sorting the PRACH resources for the respective MBS service identifiers.

In step S303, the gNB 200 broadcasts the MBS control channel at the transmission occasion for the MBS control channel based on the broadcast request (transmission request) received from the UE 100 in step S302. The UE 100 receives the MBS control channel (MBS control information), and based on this information, receives the MBS traffic channel that the UE 100 desires to receive. Note that the description of the fourth embodiment includes an example in which the MBS control channel (MBS control information) is transmitted by unicast, i.e., UE individual signalling (RRC message).

### Fourth Embodiment

The fourth embodiment will be described while focusing on differences from the above-described embodiments. The fourth embodiment may be used in conjunction with at least a part of the operation of the third embodiment.

After reception of the transmission request from the UE 100, the above-described on-demand transmission needs to wait until a transmission occasion for the MBS system information or the MBS control channel, and this may lead to an intolerable delay. In particular, a delay sensitive MBS service may fail to satisfy the delay requirements.

Thus, in the fourth embodiment, the on-demand MBS system information or the on-demand MBS control channel can be transmitted by unicast (UE individual signalling). This eliminates the need to wait until the predetermined transmission occasion, allowing delay to be suppressed.

Specifically, according to the fourth embodiment, the communication control method includes the steps of transmitting, from the UE 100 to the gNB 200, a unicast transmission request specifying the MBS system information transmitted via the broadcast control channel and/or the MBS control information transmitted via the MBS control channel, and transmitting, from the gNB 200 to the UE 100 by using unicast, the information specified in the unicast transmission request in response to the reception of the unicast transmission request.

In the fourth embodiment, one cell may include a plurality of MBS control channels. The gNB 200 may transmit, via the broadcast control channel, information for identifying the MBS control channel that can be specified in the unicast transmission request. For example, the gNB 200 broadcasts an MBS service identifier or an MBS control channel identifier corresponding to a broadcast control channel provided on demand (i.e., the broadcast control channel stopped from being broadcast). Thus, the UE 100 can appropriately determine the broadcast control channel for the unicast transmission request.

In the fourth embodiment, the UE 100 may transmit the unicast transmission request to the gNB 200 after transitioning from the RRC idle state or the RRC inactive state to the RRC connected state.

In the fourth embodiment, one cell may include a plurality of MBS control channels. The UE 100 may transmit, to the gNB 200, the unicast transmission request specifying at least one MBS control channel. Alternatively, the UE 100 may transmit, to the gNB 200, the unicast transmission request specifying at least one MBS data (at least one MBS traffic channel). Here, “specify” refers to, for example, inclusion, in the unicast transmission request, of the MBS service identifier (or the MBS control channel identifier) in which the UE 100 takes interest. Alternatively, the UE 100 may transmit a random access preamble as a unicast transmission request by using the PRACH resource associated with the MBS service identifier or the MBS control channel identifier in which the UE 100 takes interest. The gNB 200 uses unicast to transmit the MBS control information for the MBS control channel specified in the unicast transmission request as described above.

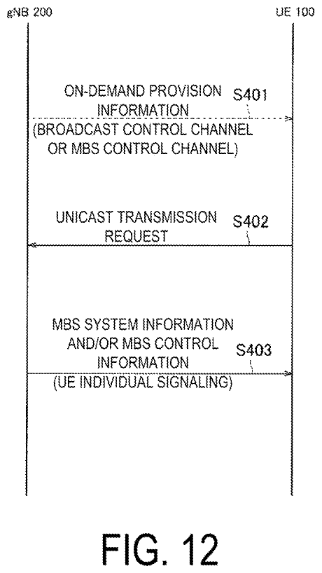

FIG. 12 is a diagram illustrating an example of operations according to the fourth embodiment. In FIG. 12, dashed lines illustrate steps that are optional.

As illustrated in FIG. 12, in step S401, when one cell supports a plurality of MBS control channels, the gNB 200 broadcasts on-demand provision information including the MBS service identifier and/or the MBS control channel identifier corresponding to the MBS control channel provided on demand (the MBS control channel not broadcast). This broadcast is performed by the broadcast control channel or the MBS control channel.

In step S402, the UE 100 transmits the unicast transmission request to the gNB 200. The UE 100 may transmit the unicast transmission request to the gNB 200 based on the on-demand provision information received in step S401. Specifically, the UE 100 may transmit the unicast transmission request to the gNB 200 only for the MBS control channel provided on demand or for the MBS traffic channel (MBS data) provided on demand.

For example, the UE 100 requests provision of the MBS control channel (MBS control information). When one cell includes a plurality of MBS control channels, the UE 100 may notify the gNB 200 of the MBS service identifier (or MBS control channel identifier) in which the UE 100 takes interest.

The UE 100 may transmit, to the gNB 200, information indicating whether the UE 100 desires to be provided with MBS system information, an MBS control channel, or both. The UE 100 may transmit, to the gNB 200, information indicating whether to request on-demand transmission by broadcast or request on-demand transmission by unicast. The UE 100 may notify the gNB 200 that the UE 100 is to access a delay sensitive MBS service.

Step S402 may be executed by the UE 100 in the RRC connected state. The UE 100 may transmit the unicast transmission request to the gNB 200 in the MBS Interest Indication or UE 100 Assistance Information, each of which is a type of RRC message. Alternatively, the UE 100 may transmit the unicast transmission request to the gNB 200 in the random access procedure using Msg3 or Msg5.

Step S402 may be executed by the UE 100 in the RRC idle state. As described in the third embodiment described above, the UE 100 may transmit the unicast transmission request to the gNB 200 by using a dedicated PRACH resource. In this case, a different PRACH resource may be allocated to each of the categories of request such as MBS service identifiers (or MBS control channel identifiers), or identifications of the SIB and the MBS control channel. Such dedicated PRACH resources may be broadcast in SIBs, or may be notified to the UE 100 by UE individual signalling.

In step S403, the gNB 200 transmits the MBS system information and/or the MBS control channel (MBS control information) to the UE 100 by UE individual signalling (e.g., the RRC message) based on the unicast transmission request received in step S402. Note that the gNB 200 may transmit only a part of the MBS control information. For example, when one MBS control channel (or a plurality of MBS control channels) has control information (such as scheduling information) for a plurality of pieces of MBS data, the gNB 200 transmits, to the UE, only the control information for the MBS data corresponding to the TMGI based on the request from the UE received in step S402 (TMGI in which the UE takes interest).

Here, the gNB 200 may pass, to the UE 100, only the scheduling information for the MBS traffic channel corresponding to the MBS service identifier requested by the UE 100 among the MBS system information and/or the MBS control channels (MBS control information).

The gNB 200 may use UE individual signalling only for delay sensitive services, and otherwise use broadcast.

Note that the gNB 200 may hand over the UE 100 to an appropriate cell instead of step S403.

### Fifth Embodiment

A fifth embodiment will be described while focusing on differences from the above-described embodiments.

In order to know whether the provision of the MBS service (MBS session) the UE 100 desires to receive has started, the UE 100 needs to check frequently transmitted MBS control channels each time. When resources for the MBS traffic channel have yet to be allocated (i.e., when the MBS transmission has yet to be started), the UE 100 consumes wasteful power.

Thus, in the fifth embodiment, the UE 100 can receive notification of the MBS service with the MBS transmission started. Accordingly, the UE 100 need not check frequently transmitted MBS control channels each time, and thus the power consumption of the UE 100 can be reduced.

According to the fifth embodiment, the communication control method includes the step of transmitting, from the gNB 200 to the UE 100, a session initiation notification including an MBS service identifier corresponding to an MBS session when the gNB 200 starts providing the MBS session.

According to the fifth embodiment, the communication control method may further include, before the MBS session is started, the steps of transmitting, from the UE 100 to the gNB 200, the MBS service identifier specified by the UE 100 and storing, by the gNB 200, the MBS service identifier from the UE 100. In starting a target MBS session corresponding to the stored MBS service identifier, the gNB 200 transmits a session initiation notification.

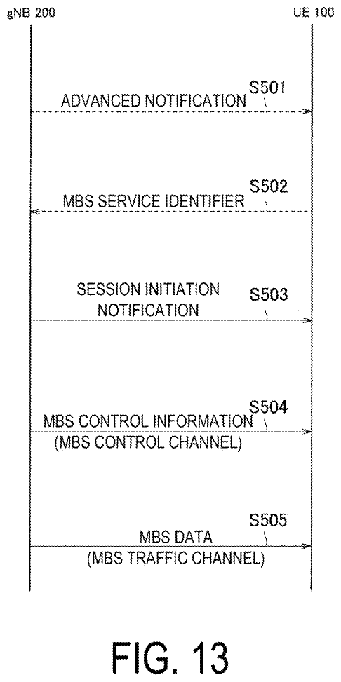

FIG. 13 is a diagram illustrating an example of operations according to the fifth embodiment. In FIG. 13, dashed lines illustrate steps that are optional.

As illustrated in FIG. 13, in step S501, the gNB 200 broadcasts an advanced notification including the MBS service identifier of each MBS service (each MBS session) that is not currently provided but that is started in the near future. Based on the advanced notification, the UE 100 can know the MBS service (MBS session) the gNB 200 starts in the near future. Note that, based on a USD provided from the network, the UE 100 may know the MBS service (MBS session) that is started in the near future.

In step S502, the UE 100 transmits, to the gNB 200, the MBS service identifier indicating the MBS service (MBS session) that the UE 100 desires to receive. The gNB 200 receives and stores the MBS service identifier.

Here, when the UE 100 is in the RRC connected state, the UE 100 may, for example, include the MBS service identifier in the MBS Interest Indication message which is a type of RRC message, and transmit the MBS Interest Indication message to the gNB 200. The MBS service identifier may be an identifier corresponding to the MBS transmission currently not provided (an identifier expected to be transmitted in the future). The UE 100 may perform notification to the gNB 200 only for the MBS service identifier included in the advanced notification received from the gNB 200 in step S501, or may notify the gNB 200 of the MBS service identifier regardless of the advanced notification.

On the other hand, when the UE 100 is in the RRC idle state or the RRC inactive state, the UE 100 may, for example, notify the gNB 200 of the MBS service identifier by using PRACH (see the fourth embodiment) or transition to the RRC connected state to transmit the above-described MBS Interest Indication.

In step S503, the gNB 200 transmits the session initiation notification (service start notification) including the MBS service identifier. The gNB 200 may transmit the session initiation notification including the MBS service identifier notified from the UE 100 in step S502.

The gNB 200 may transmit the session initiation notification at any of the following timings as a specific notification timing.
The timing at which the MBS session of the target MBS service identifier is started
The timing at which the MBS control channel control information for the target MBS service identifier is changed
The timing at which the MBS traffic channel resource for the target MBS service identifier is allocated

The gNB 200 may include at least one of the following information elements in the session initiation notification as a specific notification content.
Target MBS service identifier
Start timing for the target MBS service (H-SFN, SFN, subframe number, time of day, relative time, etc.)

The gNB 200 may transmit the session initiation notification by using any of the following manners as a specific notification method.
RRC Message (UE individual signalling or SIB)
Change notification for the SIB or MBS control channel
MAC Control Element (CE): In this case, the MAC CE may be multiplexed into a Transport Block (TB) for transmitting a Paging message, for example. The UE 100 interested in MBS reception monitors a MAC CE (that may be) transmitted at a Paging Occasion.
Paging message (Short Message): In this case, the notification in the Short Message or the Paging message may be associated with the MBS service identifier. The gNB 200 may notify the association between each bit of the Short Message and the MBS service identifier in advance by using SIBs and the like. The start timing may be notified in advance, or a value may be allocated to a bit of the Short Message. For example, when the UE 100 makes a request in step S502, the gNB 200 notifies the UE 100 of the identifier (position of the bit) and the like. In connection with the position of the bit, for example, for “00100000”, the UE 100 receives the notification that the third bit corresponds to the MBS service identifier in advance. The individual UE 100 may be notified within the Paging message. For example, notification may be provided in association with the ID of calling UE.

In step S504, the gNB 200 transmits the MBS control information (MBS control channel). In step S505, the gNB 200 transmits the MBS data (MBS traffic channel). The UE 100 receives the MBS control channel and attempts to receive the MBS traffic channel.

Here, the gNB 200 may broadcast only the MBS control channel in advance, and after the start notification in step S503, start transmission of the MBS traffic channel. Thus, the UE 100 can immediately start receiving the MBS data for the MBS service that the UE 100 desires to receive. Alternatively, the transmission of the MBS control channel may be started following the start notification. In any case, the UE 100 can reduce PDCCH monitoring operations during the period in which the MBS data for the target MBS service has yet to be transmitted, thus allowing the power consumption of the UE 100 to be reduced.

Note that, when handing over the UE 100 to the target gNB 200, the gNB 200 may include the MBS service identifier received in step S502 in a handover request to be transmitted to the target gNB 200.

### Sixth Embodiment

A sixth embodiment will be described while focusing on differences from the above-described embodiments.

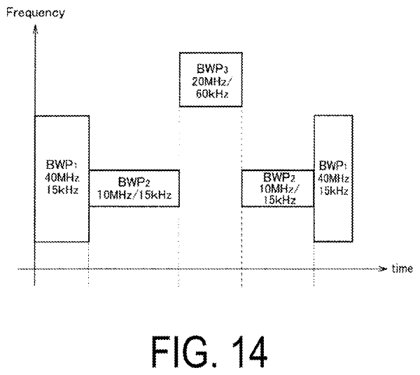

In NR, the cell may be configured with a Bandwidth Part (BWP). FIG. 14 is a diagram illustrating an example of BWPs. As illustrated in FIG. 14, BWPs are frequency parts corresponding to parts of the entire bandwidth of the cell. FIG. 14 illustrates a BWP₁ having a bandwidth of 40 MHz and a subcarrier spacing of 15 kHz, a BWP₂ having a bandwidth of 10 MHz and a subcarrier spacing of 15 kHz, and a BWP₃ having a bandwidth of 20 MHz and a subcarrier spacing of 60 kHz. A BWP is configured by the gNB 200 for the UE 100, and switching from one BWP to another BWP is controlled by the gNB 200. For example, when the UE 100 is configured with a plurality of BWPs and some of the BWPs are active whereas the others are inactive, the gNB 200 can perform control to switch the active BWP from one BWP to another BWP. The subcarrier spacing and the cyclic prefix can be variably configured for each BWP.

Under such assumptions, the gNB 200 may configure a BWP for MBS transmission. The UE 100 is preferable to be able to know information about the BWP for MBS transmission (or information about the BWP for MBS reception by the UE 100).

According to the sixth embodiment, the communication control method includes the step of transmitting, from the gNB 200 managing the cell to the UE 100, the MBS service identifier corresponding to the MBS session (MBS service), and BWP information associated with the MBS service identifier. The BWP information is information indicating a first BWP used to provide an MBS session in the cell. The BWP information (transmission BWP information) has the contents same as, and/or similar to, those of the embodiments described above.

According to the sixth embodiment, the communication control method may further include the steps of allocating, by the gNB 200, the UE 100 a second BWP to be used for unicast transmission to the UE 100, and prioritizing, by the UE 100, reception of the first BWP over reception of the second BWP when the first BWP and the second BWP overlap temporally, and the UE 100 desires to receive the MBS session. Thus, even when a collision occurs between the BWP for MBS (first BWP) and the BWP for unicast (second BWP), the UE 100 can perform the MBS reception. Alternatively, the gNB 200 may determine whether to prioritize the reception operation in the first BWP or the reception operation in the second BMP when the unicast BWP and the multicast BWP overlap temporally. In this case, the gNB 200 may notify (configure) the prioritized BWP to the UE 100. Note that the UE 100 may notify the gNB 200 which of the BWPs is prioritized. Alternatively, the UE 100 may notify the gNB 200 that the unicast BWP can be prioritized (or can be received).

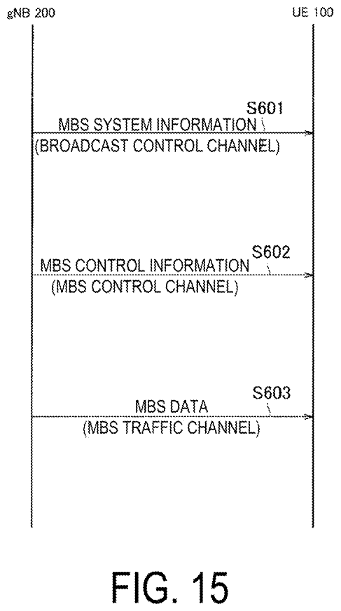

FIG. 15 is a diagram illustrating an example of operations according to the sixth embodiment.

As illustrated in FIG. 15, in step S601, the gNB 200 includes, in the MBS system information to be transmitted to the UE 100, the BWP information about the BWP for transmitting the MBS control channel. The UE 100 receives the MBS system information. When one cell includes a plurality of MBS control channels, the gNB 200 may include the BWP information in the MBS system information for each MBS control channel. Based on the BWP information included in the MBS system information, the UE 100 executes processing for receiving the MBS control information in the BWP in which the MBS control channel is transmitted.

In step S602, the gNB 200 transmits the BWP information about the BWP for transmitting the MBS traffic channel, in the MBS control channel (MBS control information) for each MBS service identifier (or for each group RNTI or for each network slice identifier). The UE 100 receives the MBS control channel. Based on the BWP information included in the MBS control channel, the UE 100 executes processing for receiving the MBS control information in the BWP in which the MBS traffic channel is transmitted (step S603). Note that when the scheduling information for the MBS traffic channel is transmitted in the broadcast control channel (MBS system information) (see the second embodiment), the gNB 200 may transmit, in the broadcast control channel (MBS system information), the BWP information about the BWP for transmitting the MBS traffic channel.

Here, the UE 100 in the RRC connected state may preferentially receive the BWP in which the MBS control channel or the MBS traffic channel is to be transmitted regardless of the active BWP (the BWP for unicast). When the active BWP (BWP for unicast) overlaps with the BMP in which the MBS control channel or the MBS traffic channel is to be transmitted, the UE 100 interested in MBS reception may preferentially receive the BWP in which the MBS control channel or the MBS traffic channel is to be transmitted.

In this case, the MBS Interest Indication may be used to notify the gNB 200 that the MBS reception is prioritized. The UE 100 may be able to prioritize a multicast BWP after notifying the priority of the MBS reception using the MBS Interest Indication. When the UE 100 loses interest in the MBS reception, the UE 100 may use the MBS Interest Indication to notify that the MBS reception is not prioritized. After notifying that the MBS reception is not prioritized using the MBS Interest Indication, the UE 100 may cancel the priority control of the multicast BWP described above. As a result, priority is given to the reception in the BWP in which the unicast is active, increasing the degree of freedom of unicast scheduling performed by the gNB 200.

Although the operations described above assume that each MBS control channel and each MBS traffic channel have a BWP configuration, the gNB 200 may broadcast a plurality of BWP configurations at one time (list format) in the MBS system information. Each of the plurality of BWP configurations may have an index value. For example, the gNB 200 broadcasts, in the MBS system information, the index value of the BWP configuration for each MBS control channel. The gNB 200 broadcasts, in the MBS control channel, the index value of the BWP configuration for each MBS traffic channel. Here, these index values may be entry numbers (indexes) of the list described above.

### Other Embodiments

In the embodiments described above, an example has been described in which the plurality of MBS control channels are associated with respective different service quality requirements. As another example of such embodiments, the MBS control channels may be classified into SFN transmission (e.g., MBSFN transmission) channels and non-SFN transmission (SC-PTM transmission) channels.

The embodiments described above can not only be separately and independently implemented, but can also be implemented in combination of two or more of the embodiments.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

Embodiments have been described above in detail with reference to the drawings, but specific configurations are not limited to those described above, and various design variation can be made without departing from the gist of the present disclosure.

Supplementary Note

### INTRODUCTION

Revised work items have been approved that are related to NR multicast and broadcast services (MBS). The purposes of the work items are as follows.
Define broadcast/multicast RAN basic functions for the UE in the RRC connected state.
Define a group scheduling mechanism that allows the UE to receive broadcast/multicast services.
The purpose includes defining an extended function required to allow simultaneous operation with unicast reception.
Define support for dynamic change of broadcast/multicast service delivery between multicast (PTM) and unicast (PTP) with predefined UE service continuity.
Define support for basic mobility with service continuity.
On the assumption that the gNB-CU includes required adjustment functions (such as functions hosted by MCE), define changes required for RAN architectures and interfaces in consideration of the results of the SA2 SI in broadcast/multi cast.
Define changes required to improve the reliability of broadcast/multicast services, for example, by UL feedback. The level of reliability is to be based on the requirements of the application/service provided.
Study support for the dynamic control of the broadcast/multicast transmission area in one gNB-DU and define what is required to enable the support, if any.
Define broadcast/multicast RAN basic functions of the UE in the RRC idle/RRC inactive state.
Define changes required to enable the UE in the RRC idle/RRC inactive state to receive Point to Multipoint transmission in order to maximize commonalities maintained between the RRC connected state and the RRC idle/RRC inactive state for configuration of PTM reception.

In the supplementary note, the first consideration for NR MBS will be discussed.

### DISCUSSION

General Considerations on Design

The LTE eMBMS involves several transmission schemes for enabling multicast/broadcast services, such as the MBSFN from Rel-9 and the SC-PTM from Rel-13. MBSFN transmission is primarily designed for multi-cell transmission, and simultaneous transmissions are performed in a (PMCH) MBSFN subframe within an MBSFN area. On the other hand, SC-PTM transmission focuses on single-cell transmission, and the MBMS is transmitted via the PDSCH. As illustrated in FIG. 6, from the perspective of Layer 2, MBSFN-related logical channels are mapped to MCHs, whereas SC-PTM-related logical channels are mapped to DL-SCHs.

Observation 1: In LTE, MCCHs and MTCHs are mapped to MCHs in the MBSFN transmission scheme, whereas SC-MCCHs and SC-MTCHs are mapped to DL-SCHs in the SC-PTM transmission scheme.

The WID has captured several limitations and assumptions, and this helps to consider what design is intended in the WI. The physical layer does not assume that new numerology or a new physical channel is introduced, as described below. This means that NR MBS-related logical channels are mapped to DL-SCHs.

Physical layer: The range of the WI is limited to the numerology, physical channels (PDCCH/PDSCH), and signals in the current Rel-15.

Observation 2: The range of the WI is limited to the existing numerology and physical channels (PDCCH/PDSCH). That is, NR MBS-related channels are assumed to be mapped to DL-SCHs.

Even if the MBSFN is not used, the multi-cell transmission will be supported by DL-SCHs in future releases, such as by a combination of, for example, of CoMP transmission and simultaneous delivery of user plane packets. Therefore, the DL-SCH conforms to the following limitations and assumptions.

Any design decision made for the WI in Rel-17 does not interfere with the introduction of the following functions in future releases.
Support for standardization of the SFN in a plurality of cells beyond the gNB-DU level

Observation 3: The DL-SCH (PDSCH) may be extended for multi-cell transmissions in future releases.

From the perspective of the above-described observations, the specifications of the SC-PTM that have been developed in LTE and cover not only the transmission schemes but also other mechanisms, such as configurations and service continuity may thus be good baselines for designing the NR MBS. Therefore, for the WI, RAN2 should reuse the existing specifications of the SC-PTM as much as possible, and study what is to be extended for the SC-PTM to support new/various use cases of the NR MBS.

Proposal 1: RAN2 should agree to employ the existing specifications of the LTE SC-PTM as baselines for design of the NR MBS such as a group scheduling mechanism, support for service continuity (for neighbor cell information and the like), and the interest indication of the UE.

Proposal 2: When Proposal 1 is agreed on, RAN2 should study what is to be extended in addition to the baselines for the SC-PTM to support new/various use cases assumed for the NR MBS.

In the next section, the specifications of the SC-PTM are used as baselines for the description. That is, Proposal 1 is assumed to be agreed on. Note that, even when a mechanism such as the MBSFN is introduced, the description can be reused.

Overview of Enhancements of functions for Control Plane

In the LTE SC-PTM, configurations are provided by two messages, i.e., SIB20 and SC-MCCH. The SIB 20 provides SC-MCCH scheduling information, and the SC-MCCH provides SC-MTCH scheduling information including the G-RNTI and the TMGI, and neighbor cell information.

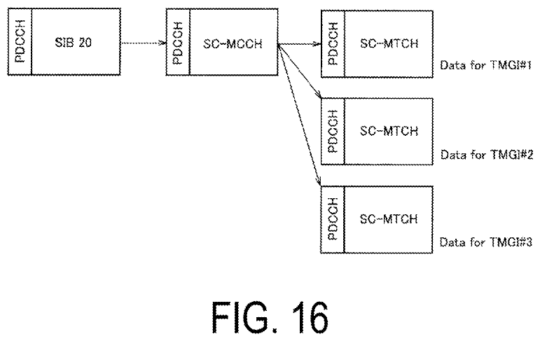

As illustrated in FIG. 16, an advantage of the LTE two-stage configuration is that the SC-MCCH scheduling is independent of the SIB20 scheduling in terms of repetition period, duration, change period, and the like. The two-stage configuration facilitates frequent scheduling/update of the SC-MCCH, particularly for delay sensitive services and/or UE that is delayed in participating in the session. According to the WID, one of the applications is group communication or the like, and thus the facilitation also applies to the NR MBS.

Observation 4: In LTE, the two-stage configuration using the SIB20 and the SC-MCCH is useful for different scheduling operations for these control channels. This is also useful for the NR MBS.

Proposal 3: RAN2 should agree on the two-stage configuration with different messages for the NR MBS, such as the SIB20 and the SC-MCCH for the SC-PTM.

In addition to Proposal 3, the NR MBS is assumed to support various types of use cases described in the WID. It may be appreciated that the NR MBS should be appropriately designed for a variety of requirements ranging from delay sensitive applications such as mission critical applications and V2X to delay tolerant applications such as IoT, in addition to the other aspects of requirements ranging from lossless application such as software delivery to UDP type streaming such as IPTV.

Therefore, the design of the control channel should take into account flexibility and the resource efficiency of the control channel. Otherwise, for example, when one control channel includes configuration of a delay tolerant service and configuration of a delay sensitive service, the control channel needs to be frequently scheduled in order to satisfy delay requirements from the delay sensitive service. This may cause more signalling overheads.

An object A of the SA2 SI relates to enabling of general MBS services via 5GS, and specified use cases possible to receive benefits from this function include (but are not limited to) public safety, mission critical applications, V2X applications, transparent IPv4/IPv6 multicast delivery, IPTV, wireless software delivery, group communications, and IoT applications.

Observation 5: The NR MBS control channel needs to be flexible to various types of use cases and to have high resource efficiency.

These use cases may involve separate configuration channels. For example, one control channel frequently provides a delay sensitive service, and another control channel infrequently provides a delay tolerant service. The LTE SC-PTM is limited in that one cell includes only one SC-MCCH. However, the NR MBS may assume more use cases than LTE, and thus should be devoid of such limitation. When a plurality of SC-MCCHs are allowed within the cell, each SC-MCCH includes a scheduling configuration with a different repetition period which can be optimized for a specific service. How to identify the SC-MCCH that provides a service in which the UE takes interest needs further study.

Proposal 4: RAN2 should discuss whether the NR MBS cell supports a plurality of control channels, as is the case with a plurality of SC-MCCHs the support of which is not included in LTE.

A new paradigm of NR is support for on-demand SI transmission. This concept may be reused for the SC-MCCH in the NR MBS, i.e., on-demand SC-MCCH. For example, the SC-MCCH for delay tolerant services is provided on demand, thus enabling resource consumption for signalling to be optimized. Of course, the network includes another option for providing the SC-MCCH for delay sensitive services and the like periodically, i.e., rather than on demand.

Proposal 5: RAN2 should discuss an option provided when the control channel is provided on an on-demand basis, as is the case with the on-demand SC-MCCH that is not included in LTE.

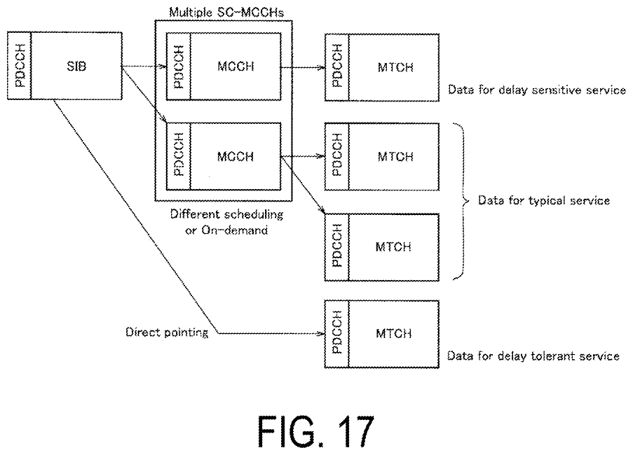

As another possibility, merging the above-described messages, i.e., one-stage configuration, may be further studied. For example, as illustrated in FIG. 17, the SIB provides SC-MTCH scheduling information directly, i.e., without the SC-MCCH. This will provide optimization for delay tolerant services and/or power sensitive UE. For example, the UE may request the SIB (on demand), and the gNB may start providing the SIB and the corresponding service after requests from a plurality of UEs. These UEs do not need to monitor the SC-MCCH that is repeatedly broadcast.

Proposal 6: RAN2 should discuss options such as direct provision of the traffic channel configuration in the SIB when multicast reception with no use of the SC-MCCH (i.e., one-stage configuration) is supported.

Overview of User Plane Extension

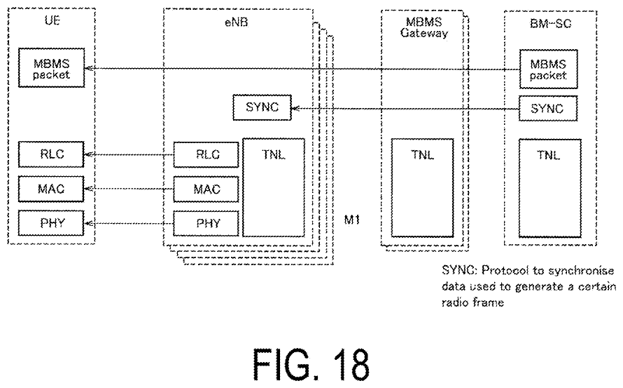

In the LTE eMBMS, regardless of the MBSFN or the SC-PTM, the Uu protocol stack includes no PDCP layer as illustrated in FIG. 18. One transmission is allowed for each logical channel, i.e., only the UM mode is used in the RLC layer, and no blind retransmission is used in the HARQ. In other words, retransmission of lost packets is dependent on the upper layer mechanism in the LTE eMBMS.

Observation 6: In the LTE eMBMS, the retransmission scheme is not supported in the AS layer.

On the other hand, the NR MBS may require a more reliable, flexible transmission scheme introduced as an AS function, as cited from the following WID.

Define support for dynamic change of broadcast/multicast service delivery between multicast (PTM) and unicast (PTP) with predefined UE service continuity.

Define support for basic mobility with service continuity.

Define changes required to improve the reliability of broadcast/multicast services, for example, by UL feedback. The level of reliability should be based on the requirements of the application/service provided.

Observation 7: The NR MBS may require several enhancements of functions for improving the reliability and flexibility of multicast transmission and reception as a function of the AS layer.

Group cast retransmission may be considered to be processed by using MAC (HARQ), RLC (ARQ), and/or the PDCP (status report). Similarly to the Uu, these mechanisms may help compensation for degraded UE mobility, i.e., degraded radio quality and/or lost packets due to switching of a transport path.

The multicast/groupcast HARQ feedback has not been introduced in LTE. On the other hand, in Rel-16 NR V2X, the sidelink groupcast HARQ feedback, that is, the ACK/NACK or NACK-only, is supported. This is one possibility to be reused to improve the performance of the NR MBS. The detailed decision ultimately depends on RAN1, but RAN2 may discuss the usefulness of HARQ feedback/re-transmission for improving the reliability of multicast reception at the UE in the idle, inactive, and connected states.

Proposal 7: RAN2 should discuss whether the HARQ feedback/retransmission is useful for the NR MBS multicast for the UE in the RRC idle, inactive, and connected states.

For unicast, the HARQ and the ARQ support a double feedback loop to improve the reliability of reception. When this also applies to the groupcast in the NR MBS, as a possibility, a method for introducing the ARQ, i.e., the RLC AM mode should be discussed at least to improve the reliability of the UE in the connected state. However, it may be typically assumed that a pair of uplink channels is not available for groupcast. Therefore, a potential challenge is a method for the UE to transmit feedback (STATUS PDU) to the gNB.

Proposal 8: RAN2 should discuss whether the NR MBS multicast supports the RLC AM mode at least for the UE in the RRC connected state.

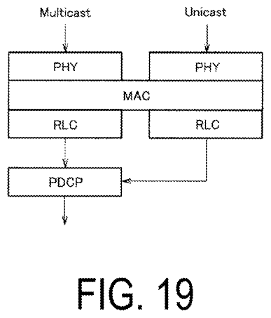

For example, when lossless delivery needs to be taken into account during handover of the NR MBS, as in the use case of software delivery, the PDCP helps recover dropped packet as in the current case. FIG. 19 illustrates enhancements of functions for reliable reception and multicast/unicast switching. Support for the PDCP layer has another advantage that a multicast bearer can be configured by using split bearers and/or duplicated by using a unicast bearer. This is also one of the potential mechanisms of the “dynamic change of broadcast/multicast service delivery between multicast (PTM) and unicast (PTP) with predefined UE service continuity” as described in the WID. Whether multicast reception can support a variety of PDCP functions such as header compression and encryption needs further studies.

Proposal 9: RAN2 should discuss whether the PDCP layer is supported at least by the NR MBS groupcast in the UE in the RRC connected state.

Finally, whether the NR MBS protocol stack requires the SDAP should be studied. NR supports the SDAP layer and processes a QoS flow in the radio bearer. On the other hand, the SDAP layer is not included in the known LTE, and thus not included in the eMBMS. Although the SDAP layer may be assumed not to affect reception of multicast data, the need for the SDAP layer may actually depend on the assumptions/requirements of the upper layer. Accordingly, for the necessity, RAN2 may need to wait for the other WGs to proceed.

Observation 8: RAN2 may need to check with the other WGs whether the NR MBS requires the SDAP layer.

1. A communication control method used in a mobile communication system comprising a base station for providing a multicast broadcast service (MBS) to a user equipment, the communication control method comprising:
transmitting, by the base station configured to manage a cell, to the user equipment, MBS bandwidth part information, wherein
the MBS bandwidth part information indicates a first bandwidth part used to provide the MBS session in the cell.

2. The communication control method according to claim 1, further comprising:
allocating, by the base station, to the user equipment, a second bandwidth part used for unicast transmission to the user equipment; and
prioritizing, by the user equipment, reception of the first bandwidth part over reception of the second bandwidth part when the first bandwidth part and the second bandwidth part temporally overlap, and the user equipment desires to receive the MBS session.

3. A communication control method used in a mobile communication system comprising a base station for providing a multicast broadcast service (MBS) to a user equipment, the communication control method comprising:
transmitting, by the base station configured to manage a cell, in the cell, a plurality of MBS control channels associated with respective different service quality requirements; and
receiving, by the user equipment, an MBS control channel of the plurality of MBS control channels corresponding to a service quality requirement of the different service quality requirements requested by the user equipment.

4. The communication control method according to claim 3, wherein
the plurality of MBS control channels comprises a first MBS control channel for a first MBS service and a second MBS control channel for a second MBS service requiring a low latency compared to the first MBS service.

5. The communication control method according to claim 1, wherein
the plurality of MBS control channels are associated with respective different network slices.

6. The communication control method according to claim 5, wherein
each of the plurality of MBS control channels transmits MBS control information comprising a network slice identifier identifying a corresponding network slice.

7. The communication control method according to claim 5, further comprising:
receiving, by the base station or the user equipment, a network slice identifier associated with an MBS service identifier, from a network node.

8. A communication control method used in a mobile communication system comprising a base station for providing a multicast broadcast service (MBS) to a user equipment, the communication control method comprising:
transmitting, by the base station, MBS system information via a broadcast control channel, wherein
the MBS system information comprises first MBS system information indicating scheduling of an MBS control channel for transmitting MBS control information and second MBS system information indicating scheduling of an MBS traffic channel for transmitting MBS data.

9. The communication control method according to claim 8, further comprising:
transmitting, by the user equipment, to the base station, a transmission request for requesting transmission of the MBS system information, wherein
the transmission request comprises information identifying MBS system information requested by the user equipment out of the first MBS system information and the second MBS system information.
